(19) United States
(12) Patent Application Publication
(10) Pub. No.: US 2024/0380350 A1
(43) Pub. Date: Nov. 14, 2024

(54) POWER CONVERTER, MOTOR DRIVE APPARATUS, AND REFRIGERATION CYCLE APPLIED APPARATUS

(71) Applicant: Mitsubishi Electric Corporation, Tokyo (JP)

(72) Inventors: Tomohiro KUTSUKI, Tokyo (JP); Hajime TOYODA, Tokyo (JP); Koichi ARISAWA, Tokyo (JP); Takaaki TAKAHARA, Tokyo (JP); Haruka MATSUO, Tokyo (JP)

(21) Appl. No.: 18/696,598

(22) PCT Filed: Dec. 2, 2021
(86) PCT No.: PCT/JP2021/044279

§ 371 Date: Mar. 28, 2024

(51) Int. Cl. H02P 27/08; H02P 21/36

(52) U.S. Cl. CPC H02P 27/08; H02P 21/36; F25B 2600/021

(57) ABSTRACT

A power converter includes: a rectifier unit that rectifies a power supply voltage applied from a commercial power supply; a capacitor connected to an output end of the rectifier unit; an inverter that converts direct-current power output from the capacitor into alternating-current power and outputs the alternating-current power to a device equipped with a motor; and a control unit that performs power supply ripple compensation control of reducing ripple of a capacitor current, which is a charge/discharge current of the capacitor, by controlling the inverter. The control unit determines whether or not a compensation operation by the power supply ripple compensation control is normal and, when determining that the compensation operation is not normal, performs control of reducing a drive speed of the motor or stopping driving of the motor.

### CROSS-REFERENCE TO RELATED APPLICATION

This application is a U.S. National Stage Application of PCT/JP2021/044279 filed on Dec. 2, 2021, the contents of which are incorporated herein by reference.

### FIELD

The present disclosure relates to a power converter that converts alternating-current power into desired power, a motor drive apparatus, and a refrigeration cycle applied apparatus.

### BACKGROUND

Conventionally, there is a power converter that converts alternating-current power supplied from an alternating-current power supply into desired alternating-current power, and supplies the alternating-current power to a load such as an air conditioner. For example, Patent Literature 1 below discloses a technique in which a power converter as a control device of an air conditioner rectifies alternating-current power supplied from an alternating-current power supply by a diode stack as a rectifier unit, converts the power further smoothed by a smoothing capacitor into desired alternating-current power by an inverter including a plurality of switching elements, and outputs the alternating-current power to a compressor motor as a load.

### PATENT LITERATURE

Patent Literature 1: Japanese Patent Application Laid-open No. H7-71805

However, according to the above conventional technique, a high ripple current flowing through the smoothing capacitor has caused a problem of accelerating aging of the smoothing capacitor. In response to this problem, the operation of the inverter is controlled such that ripple corresponding to a detected value of a capacitor voltage is superimposed on a drive pattern of the motor. Since ripple in the capacitor voltage depends on a power supply frequency, this control is called “power supply ripple compensation control”. The power supply frequency is a frequency of a power supply voltage applied from the alternating-current power supply.

When the power supply ripple compensation control operates as expected, the aging of the smoothing capacitor is slowed down. On the other hand, when the power supply ripple compensation control does not operate as expected, the increase in the ripple current increases electrical stress on the smoothing capacitor, whereby the aging of the smoothing capacitor is accelerated. It is thus important to check whether the power supply ripple compensation control operates as expected and to appropriately respond thereto.

### SUMMARY

The present disclosure has been made in view of the above, and an object of the present disclosure is to provide a power converter capable of making an appropriate response when the power supply ripple compensation control does not operate as expected.

In order to solve the above problem and achieve the object, a power converter according to the present disclosure includes a rectifier unit, a capacitor connected to an output end of the rectifier unit, an inverter connected across the capacitor, and a control unit. The rectifier unit rectifies a power supply voltage applied from an alternating-current power supply. The inverter converts direct-current power output from the capacitor into alternating-current power, and outputs the alternating-current power to a device equipped with a motor. The control unit performs first control of reducing ripple of a capacitor current, which is a charge/discharge current of the capacitor, by controlling the inverter. The control unit determines whether or not a compensation operation by the first control is normal and, when determining that the compensation operation is not normal, performs second control of reducing a drive speed of the motor or stopping driving of the motor.

The power converter according to the present disclosure has an effect of being able to make an appropriate response when the power supply ripple compensation control does not operate as expected.

### DETAILED DESCRIPTION

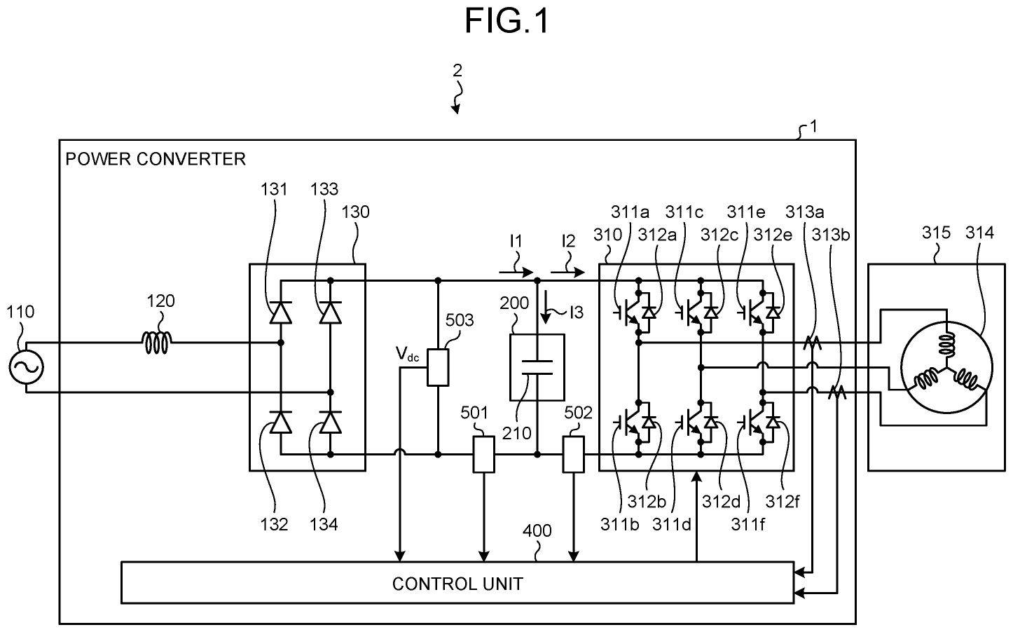

FIG. 1 is a diagram illustrating an example of a configuration of a power converter according to a first embodiment.

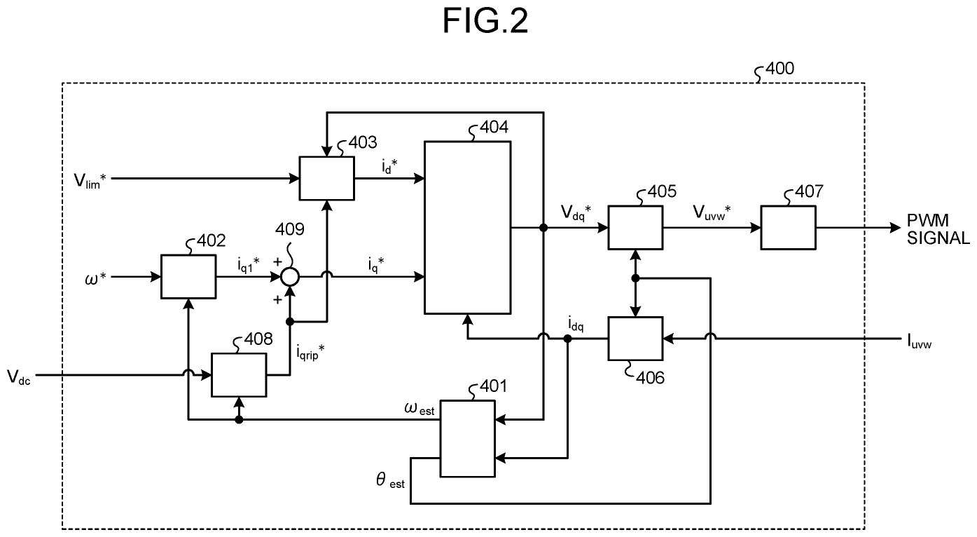

FIG. 2 is a block diagram illustrating an example of a configuration of a control unit included in the power converter according to the first embodiment.

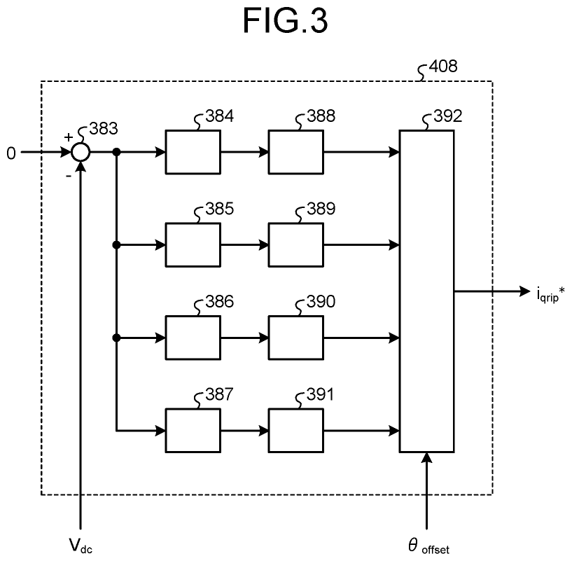

FIG. 3 is a diagram illustrating an example of a configuration of a q-axis current ripple calculation unit included in the control unit according to the first embodiment.

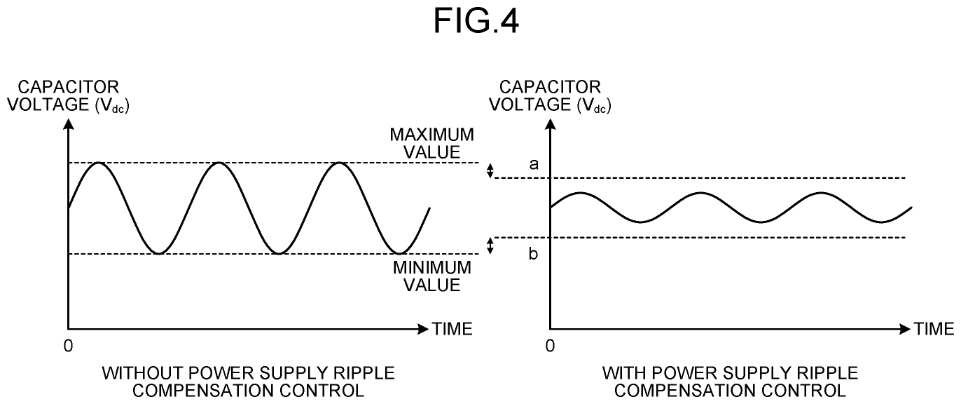

FIG. 4 is a set of graphs provided for explaining a threshold setting method in the first embodiment.

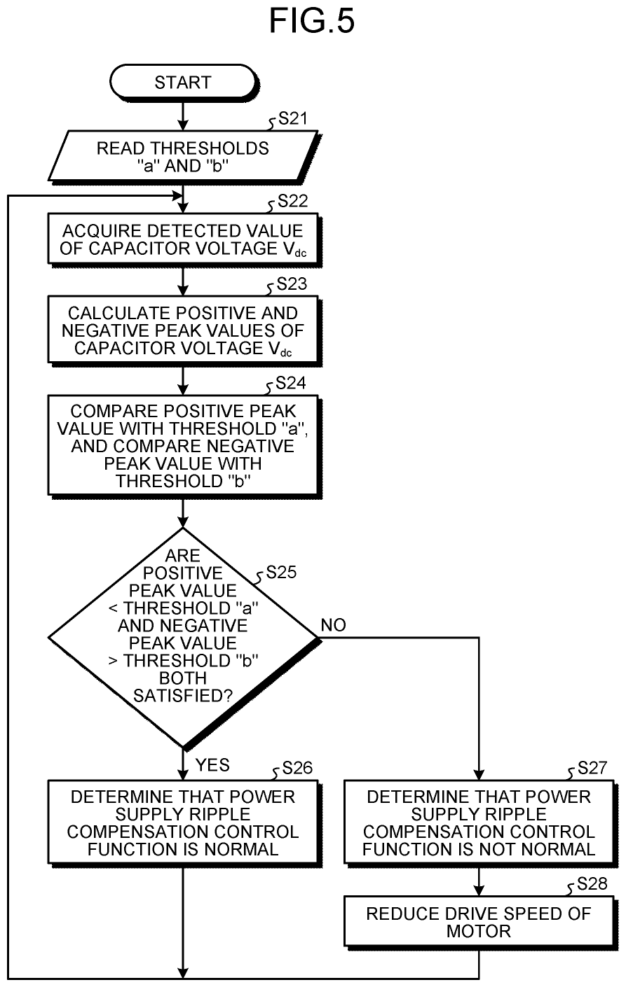

FIG. 5 is a flowchart provided for explaining an operation of the control unit according to the first embodiment.

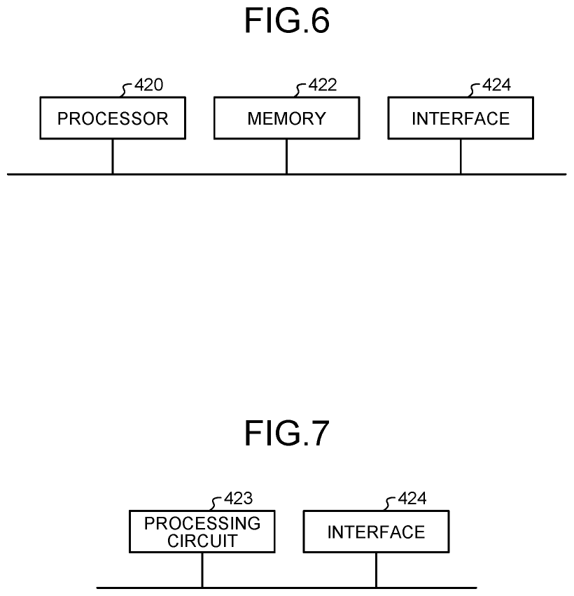

FIG. 6 is a block diagram illustrating an example of a hardware configuration that implements functions of the control unit according to the first embodiment.

FIG. 7 is a block diagram illustrating another example of the hardware configuration that implements the functions of the control unit according to the first embodiment.

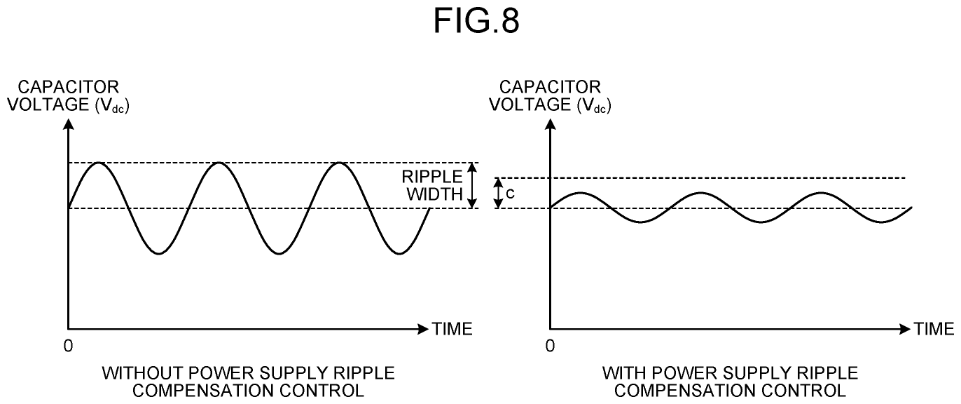

FIG. 8 is a set of graphs provided for explaining a threshold setting method in a second embodiment.

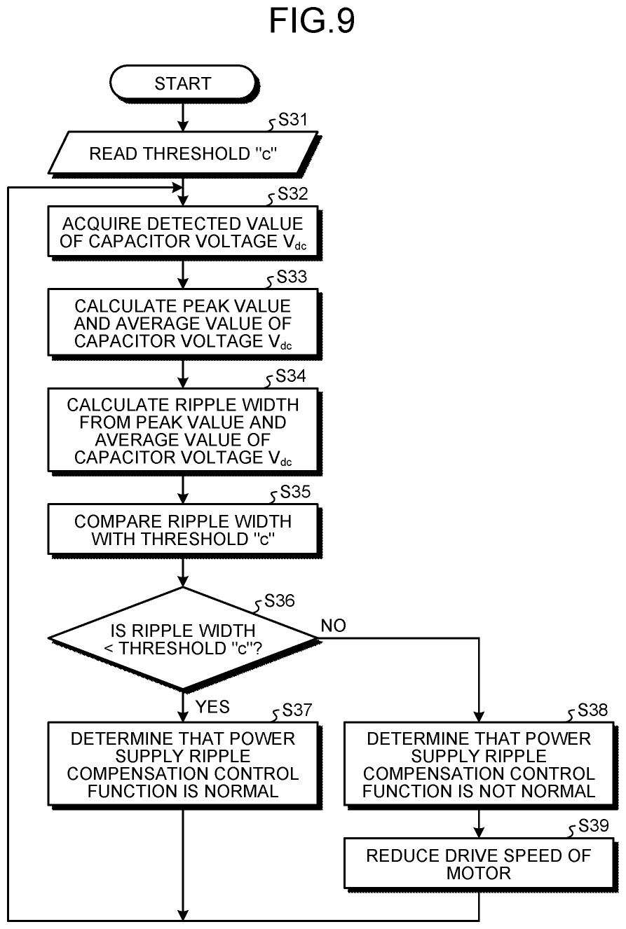

FIG. 9 is a flowchart provided for explaining an operation of a control unit according to the second embodiment.

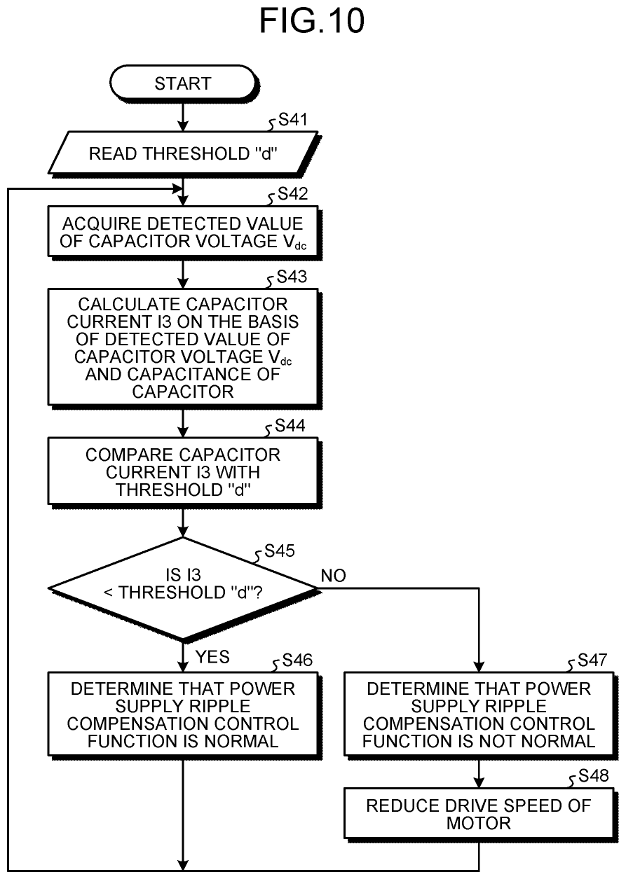

FIG. 10 is a flowchart provided for explaining an operation of a control unit according to a third embodiment.

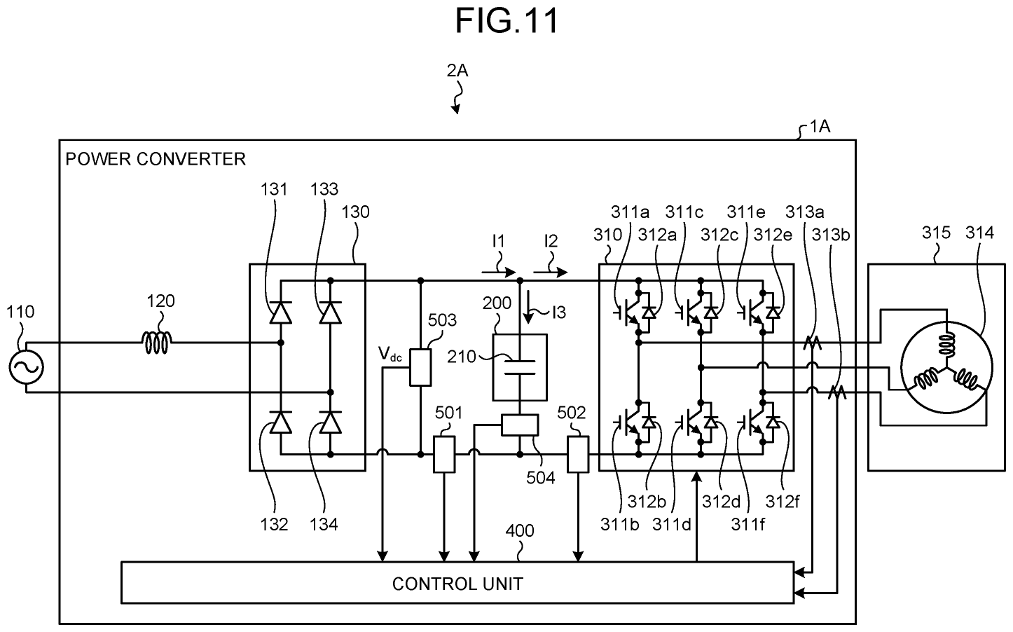

FIG. 11 is a diagram illustrating an example of a configuration of a power converter according to a fourth embodiment.

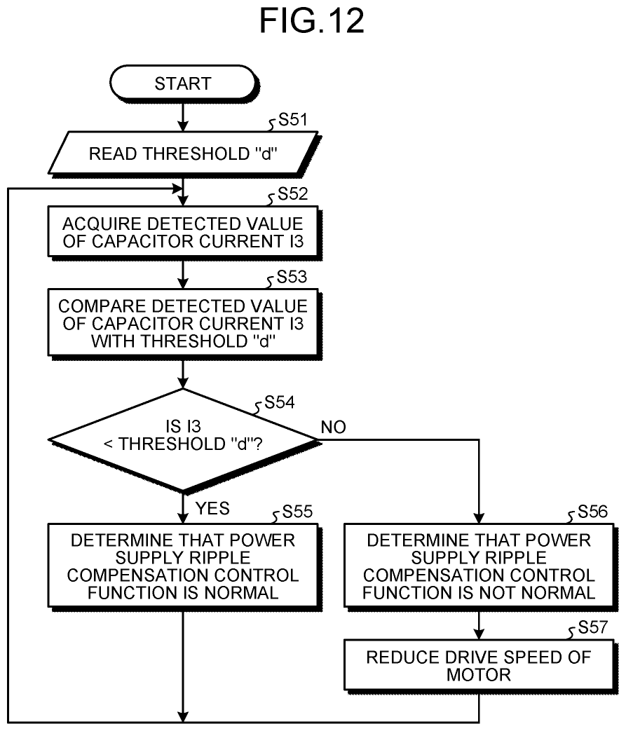

FIG. 12 is a flowchart provided for explaining an operation of a control unit according to the fourth embodiment.

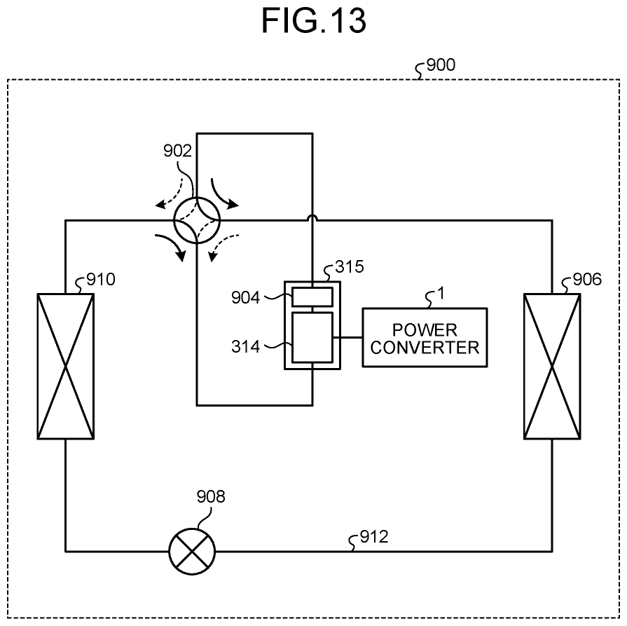

FIG. 13 is a diagram illustrating an example of a configuration of a refrigeration cycle applied apparatus according to a fifth embodiment.

### DESCRIPTION OF EMBODIMENTS

Hereinafter, a power converter, a motor drive apparatus, and a refrigeration cycle applied apparatus according to embodiments of the present disclosure will be described in detail with reference to the drawings.

### First Embodiment

FIG. 1 is a diagram illustrating an example of a configuration of a power converter 1 according to a first embodiment. In FIG. 1, the power converter 1 is connected to a commercial power supply 110 and a compressor 315. The commercial power supply 110 is an example of an alternating-current power supply, and the compressor 315 is an example of a device in the first embodiment. The compressor 315 is equipped with a motor 314. The power converter 1 and the motor 314 included in the compressor 315 make up a motor drive apparatus 2.

The power converter 1 includes a reactor 120, a rectifier unit 130, current detection units 501 and 502, a voltage detection unit 503, a smoothing unit 200, an inverter 310, current detection units 313a and 313b, and a control unit 400.

The reactor 120 is connected between the commercial power supply 110 and the rectifier unit 130. The rectifier unit 130 includes a bridge circuit formed by rectifier elements 131 to 134. The rectifier unit 130 rectifies and outputs a power supply voltage applied from the commercial power supply 110. The rectifier unit 130 performs full-wave rectification.

The smoothing unit 200 is connected to an output end of the rectifier unit 130. The smoothing unit 200 includes a capacitor 210 as a smoothing element, and smooths the rectified voltage output from the rectifier unit 130. The capacitor 210 is, for example, an electrolytic capacitor, a film capacitor, or the like. The capacitor 210 is connected to the output end of the rectifier unit 130. The capacitor 210 has a capacitance corresponding to the degree of smoothing the rectified voltage. As a result of the smoothing, the voltage generated in the capacitor 210 does not have a full-wave rectified waveform of the rectified voltage but has a waveform in which a voltage ripple corresponding to the frequency of the commercial power supply 110 is superimposed on a direct-current component, and does not ripple much. The frequency of the voltage ripple is mainly composed of a component that is two times the frequency of the power supply voltage in the case of the commercial power supply 110 having a single phase, or mainly composed of a component that is six times the frequency of the power supply voltage in the case of the commercial power supply 110 having three phases. In a case where the power input from the commercial power supply 110 and the power output from the inverter 310 are the same, the amplitude of the voltage ripple is determined by the capacitance of the capacitor 210. However, the power converter 1 according to the present disclosure avoids an increase in the capacitance in order to avoid an increase in cost of the capacitor 210. This results in a certain level of voltage ripple in the capacitor 210. For example, the voltage of the capacitor 210 ripples within a range in which the maximum value of the voltage ripple is less than two times the minimum value thereof.

The current detection unit 501 detects a rectified current I1 flowing out of the rectifier unit 130, and outputs a detected value of the rectified current I1 to the control unit 400. The current detection unit 502 detects an inverter input current I2 that is a current flowing into the inverter 310, and outputs a detected value of the inverter input current I2 to the control unit 400. The voltage detection unit 503 detects a capacitor voltage V_{dc} that is the voltage of the capacitor 210, and outputs a detected value of the capacitor voltage V_{dc} to the control unit 400. The voltage detection unit 503 can be used as a detection unit that detects a power state of the capacitor 210.

The inverter 310 is connected across the smoothing unit 200, that is, the capacitor 210. The inverter 310 includes switching elements 311a to 311f and freewheeling diodes 312a to 312f. The inverter 310 turns on and off the switching elements 311a to 311f under the control of the control unit 400, converts the power output from the rectifier unit 130 and the smoothing unit 200 into alternating-current power having desired amplitude and phase, and outputs the alternating-current power to the compressor 315 that is the device equipped with the motor 314.

The current detection units 313a and 313b each detect a current value of one phase among three phase motor currents output from the inverter 310 to the motor 314. The detected values by the current detection units 313a and 313b are input to the control unit 400. On the basis of the detected values of the currents of any two phases detected by the current detection units 313a and 313b, the control unit 400 calculates the current of the remaining one phase.

The motor 314 installed in the compressor 315 rotates in accordance with the amplitude and phase of the alternating-current power supplied from the inverter 310 and performs a compression operation. In a case where the compressor 315 is a hermetic compressor used in an air conditioner or the like, a load torque of the compressor 315 can be regarded as a constant torque load in many cases.

Note that although FIG. 1 illustrates a case where the motor windings of the motor 314 are in Y connection, the present disclosure is not limited to such a case. The motor windings of the motor 314 may be in A connection or may be designed to be able to switch between Y connection and A connection.

Moreover, in the power converter 1, the configuration and placement of each unit illustrated in FIG. 1 are an example and not limited to the example illustrated in FIG. 1. For example, the reactor 120 may be placed at a subsequent stage of the rectifier unit 130. In addition, the power converter 1 may include a booster, or the rectifier unit 130 may have a function of a booster. In the following description, the current detection units 501 and 502, the voltage detection unit 503, and the current detection units 313a and 313b may be simply referred to as “detection units”. In addition, the current values detected by the current detection units 501 and 502, the voltage value detected by the voltage detection unit 503, and the current values detected by the current detection units 313a and 313b may be simply referred to as “detected values”.

The control unit 400 acquires the detected value of the rectified current I1 detected by the current detection unit 501, the detected value of the inverter input current I2 detected by the current detection unit 502, and the detected value of the capacitor voltage V_{dc} detected by the voltage detection unit 503. The control unit 400 also acquires the detected values of the motor currents detected by the current detection units 313a and 313b. The control unit 400 uses the detected values detected by the detection units to control the operation of the inverter 310, specifically, on/off of the switching elements 311a to 311f included in the inverter 310. In addition, the control unit 400 controls the operation of the inverter 310 such that the inverter 310 outputs, to the compressor 315, the alternating-current power containing ripple corresponding to ripple of the power flowing from the rectifier unit 130 into the capacitor 210 of the smoothing unit 200. The ripple corresponding to the ripple of the power flowing into the capacitor 210 of the smoothing unit 200 is, for example, ripple that varies depending on the frequency of the ripple of the power flowing into the capacitor 210 of the smoothing unit 200 or the like. As a result, the control unit 400 reduces a capacitor current I3 that is a charge/discharge current of the capacitor 210. The control unit 400 performs control such that any of the speed, the voltage, and the current of the motor 314 achieves a desired state. Note that the control unit 400 need not use all the detected values acquired from the detection units, and can perform control using some of the detected values.

In a case where the motor 314 is used for driving the compressor 315 that is a hermetic compressor, it is often difficult in terms of structure and cost to attach a position sensor for detecting a rotor position to the motor 314. Therefore, the control unit 400 performs position sensorless control on the motor 314. Methods of position sensorless control of the motor 314 include two types, that is, constant primary flux control and sensorless vector control. The first embodiment will provide a description based on the sensorless vector control as an example. Note that the control method described below can also be applied to the constant primary flux control by a minor change.

Next, a characteristic operation of the control unit 400 in the first embodiment will be described. First, the rectified current I1 flowing out of the rectifier unit 130 is affected by a power supply phase of the commercial power supply 110, characteristics of elements installed in front of and behind the rectifier unit 130, and the like. As a result, the rectified current I1 has characteristics including the power supply frequency and a harmonic component (frequency component that is an integral multiple being two times or more) of the power supply frequency. Also, in the capacitor 210, when the capacitor current I3 is large, the aging of the capacitor 210 is accelerated. In particular, in a case where an electrolytic capacitor is used as the capacitor 210, the aging is accelerated at an increased rate. Therefore, the control unit 400 performs control of bringing the capacitor current I3 close to zero by controlling the inverter 310 such that the inverter input current I2 is equal to the rectified current I1. This slows down the aging of the capacitor 210. However, a ripple component caused by pulse width modulation (PWM) is superimposed on the inverter input current I2. The control unit 400 thus needs to control the inverter 310 in consideration of the ripple component. The control unit 400 controls the inverter 310 such that a value obtained by removing the PWM ripple from the inverter input current I2 from the capacitor 210 to the inverter 310 matches the rectified current I1, and adds ripple to the power output to the motor 314. The control unit 400 causes the inverter input current I2 to ripple appropriately to perform control for reducing the capacitor current I3, that is, the power supply ripple compensation control.

As described above, in the first embodiment, the control unit 400 performs the power supply ripple compensation control on the capacitor 210. The power supply ripple compensation control is compensation control performed to reduce a power supply ripple component included in the capacitor current I3. Note that the power supply ripple component is a ripple component of the capacitor current I3 that can be generated in the capacitor current I3 due to the power supply frequency and the harmonic component (frequency component that is the integral multiple being two times or more) of the power supply frequency. The power supply ripple compensation control can be performed on the basis of the detected value of at least one of the rectified current I1, the inverter input current I2, the capacitor current I3, and the capacitor voltage V_{dc} that are information for grasping the power state of the capacitor 210.

Next, a configuration of the control unit 400 that implements the aforementioned functions will be described. FIG. 2 is a block diagram illustrating an example of the configuration of the control unit 400 included in the power converter 1 according to the first embodiment. The control unit 400 includes a rotor position estimation unit 401, a speed control unit 402, a flux weakening control unit 403, a current control unit 404, coordinate conversion units 405 and 406, a PWM signal generation unit 407, a q-axis current ripple calculation unit 408, and an addition unit 409.

The rotor position estimation unit 401 uses a dq-axis voltage command vector V_{dq}* and a dq-axis current vector i_{dq} for driving the motor 314 to estimate, for a rotor (not illustrated) included in the motor 314, an estimated phase angle θₑₛₜ as a direction of the magnetic pole of the rotor on a dq-axis and an estimated speed ωₑₛₜ as a speed of the rotor.

The speed control unit 402 automatically adjusts a q-axis current command i_{q1}* such that a speed command ω* matches the estimated speed ωₑₛₜ. In a case where the power converter 1 is used in an air conditioner or the like as a refrigeration cycle applied apparatus, the speed command ω* is based on, for example, a temperature detected by a temperature sensor (not illustrated), information indicating a set temperature instructed from a remote control that is an operation unit (not illustrated), operation mode selection information, operation start/end instruction information, and the like. The operation mode is, for example, heating, cooling, dehumidifying, and the like.

The flux weakening control unit 403 automatically adjusts a d-axis current command i_{d}* such that an absolute value of the dq-axis voltage command vector V_{dq}* falls within a limit value of a voltage limit value Vₗᵢₘ*. Also, in the first embodiment, the flux weakening control unit 403 performs flux weakening control in consideration of a q-axis current ripple command i_{qrip}* calculated by the q-axis current ripple calculation unit 408. There are roughly two methods in performing the flux weakening control where either of the methods may be used, the methods being a method of calculating the d-axis current command i_{d}* from a voltage limit ellipse equation and a method of calculating the d-axis current command i_{d}* such that a deviation between absolute values of the voltage limit value Vₗᵢₘ* and the dq-axis voltage command vector V_{dq}* equals zero.

The current control unit 404 automatically adjusts the dq-axis voltage command vector V_{dq}* such that the dq-axis current vector i_{dq} follows the d-axis current command i_{d}* and a q-axis current command i_{q}*.

The coordinate conversion unit 405 performs coordinate conversion on the dq-axis voltage command vector V_{dq}* in the dq coordinates to obtain a voltage command V_{uvw}* in an alternating-current value in accordance with the estimated phase angle θₑₛₜ.

The coordinate conversion unit 406 performs coordinate conversion on a current I_{uvw} in an alternating-current value flowing through the motor 314 to obtain the dq-axis current vector i_{dq} in the dq coordinates in accordance with the estimated phase angle θₑₛₜ. As described above, the control unit 400 can acquire the current I_{uvw} flowing through the motor 314 by using, among the current values of the three phases output from the inverter 310, the current values of the two phases detected by the current detection units 313a and 313b and calculating the current value of the remaining one phase using the current values of the two phases.

The PWM signal generation unit 407 generates a PWM signal on the basis of the voltage command V_{uvw}* obtained by the coordinate conversion by the coordinate conversion unit 405. The control unit 400 outputs the PWM signal generated by the PWM signal generation unit 407 to the switching elements 311a to 311f of the inverter 310, thereby applying a voltage to the motor 314.

The q-axis current ripple calculation unit 408 calculates the q-axis current ripple command i_{qrip}* on the basis of the detected value of the capacitor voltage V_{dc} detected by the voltage detection unit 503 and the estimated speed ωₑₛₜ.

The addition unit 409 adds the q-axis current command i_{q1}* output from the speed control unit 402 and the q-axis current ripple command i_{qrip}* calculated by the q-axis current ripple calculation unit 408, and outputs the q-axis current command i_{q}* that is the calculated value of the addition as a torque current command to the current control unit 404.

FIG. 3 is a diagram illustrating an example of a configuration of the q-axis current ripple calculation unit 408 included in the control unit 400 according to the first embodiment. The q-axis current ripple calculation unit 408 is configured as a feedback controller with a command value set to zero. Usually, the feedback controller has a lower control response than a feedforward controller and is not suitable for reducing harmonic ripple, but various harmonic ripple reduction means have been proposed in the past. A well-known method is a method using Fourier coefficient calculation and a proportional integral differential (PID) controller. The q-axis current ripple calculation unit 408 includes a subtraction unit 383, Fourier coefficient calculation units 384 to 387, PID control units 388 to 391, and an alternating current restoration unit 392.

The subtraction unit 383 calculates a deviation between the command value that is zero and the capacitor voltage V_{dc}. With the use of the theory of Fourier series expansion, it is possible to extract amplitudes of a sine (sin) signal component and a cosine (cos) signal component of a specific frequency included in the deviation. Assuming that the power supply frequency is a 1f component, the Fourier coefficient calculation units 384 to 387 calculate amplitudes of a sin 2f component, a cos 2f component, a sin 4f component, and a cos 4f component included in the deviation, respectively. When the angular frequency of an alternating-current power supply voltage is represented by “ωᵢₙ”, detection signals multiplied in the Fourier coefficient calculation units 384 to 387 are sin 2ωᵢₙt, cos 2ωᵢₙt, sin 4ωᵢₙt, and cos 4ωᵢₙt, respectively. In addition, the detection signals are the amplitudes of the sin 2f component, the cos 2f component, the sin 4f component, and the cos 4f component in which, for each component, twice an average value of the product of an input signal and the detection signal is included in the deviation. That is, the Fourier coefficient calculation units 384 to 387 each calculate the amplitude of the component included in the deviation between the detected value and the command value and corresponding to the power supply frequency of the commercial power supply 110. When the capacitor current I3 has a periodic waveform, output signals of the Fourier coefficient calculation units 384 to 387 are substantially constant.

The PID control units 388 to 391 perform proportional-integral-derivative control, that is, PID control such that the specific frequency components of the deviation each equal zero. The proportional gain and the derivative gain may be zero, but the integral gain needs to have a non-zero value in order to converge the deviation to zero. Therefore, the PID control units 388 to 391 mainly perform integral operation. Normally, the output of integral control changes gently, so that the output of the PID control units 388 to 391 can also be regarded as substantially constant.

Here, the capacitor voltage V_{dc} is obtained by dividing the charge accumulated in the capacitor current 13, that is, an integral value of the capacitor current I3, by the capacitance of the capacitor 210. Therefore, there is a phase difference of 90 degrees between the capacitor current I3 and the capacitor voltage V_{dc}. The alternating current restoration unit 392 thus needs to determine the q-axis current ripple command i_{qrip}* in consideration of the phase difference of 90 degrees. When the phase difference of 90 degrees is represented by θ_{offset} (=π/2 [rad]), the alternating current restoration unit 392 performs restoration calculation as follows.

First, the detection signals multiplied in the Fourier coefficient calculation units 384 to 387 are, as described above, sin 2ωᵢₙt, cos 2ωᵢₙt, sin 4ωᵢₙt, and cos 4ωᵢₙt, respectively. In order to restore the outputs of the PID control units 388 to 391 to the alternating current component, the alternating current restoration unit 392 multiplies the outputs by sin 2 (ωᵢₙt+θ_{offset}), cos 2 (ωᵢₙt+θ_{offset}), sin 4 (ωᵢₙt+θ_{offset}), and cos 4 (ωᵢₙt+θ_{offset}), in which a restoration signal is shifted by the phase difference θ_{offset}, and then adds the multiplied results to determine the q-axis current ripple command i_{qrip}*. The alternating current restoration unit 392 thus generates the q-axis current ripple command i_{qrip}* that is a command for the ripple to reduce the capacitor current I3.

Here, the case of using the sensorless vector control method has been illustrated, but the present disclosure can also be applied to the constant primary flux control by adding some modification so that ripple is added to the speed command, the voltage command, and the like. In addition, here, the example of generating the q-axis current ripple command i_{qrip}* on the basis of the capacitor voltage V_{dc} has been illustrated, but the present disclosure is not limited to this example. The q-axis current ripple command i_{qrip}* may be generated on the basis of the capacitor current I3. The capacitor current I3 can be obtained by calculation using the detected value of the rectified current I1 detected by the current detection unit 501 and the detected value of the inverter input current I2 detected by the current detection unit 502. Alternatively, as in a third embodiment described later, the capacitor current I3 may be obtained by calculation on the basis of the capacitor voltage V_{dc} and the capacitance of the capacitor 210. Yet alternatively, as in a fourth embodiment described later, the capacitor current I3 may be directly detected.

Next, main points of the operation of the power converter 1 according to the first embodiment will be described. In the first embodiment, in order to determine whether the power supply ripple compensation control operates as expected, in other words, whether a power supply ripple compensation control function is normal or not, a new idea is introduced for setting a threshold used for the determination. Note that, in the present description, the “power supply ripple compensation control” may be simply referred to as “first control”.

FIG. 4 is a set of graphs provided for explaining a threshold setting method in the first embodiment. The left side of FIG. 4 illustrates a time-varying waveform of the capacitor voltage V_{dc} in a case where the power supply ripple compensation control is not performed. The case where the power supply ripple compensation control is not performed means that the power supply ripple compensation control function is not active. The right side of FIG. 4 illustrates a time-varying waveform of the capacitor voltage V_{dc} in a case where the power supply ripple compensation control is performed. The case where the power supply ripple compensation control is performed means that the power supply ripple compensation control function is active. Note that, in order to prevent the power supply ripple compensation control function from being active, it is only necessary to stop the operation of the q-axis current ripple calculation unit 408 in FIG. 2 or to not input the output of the q-axis current ripple calculation unit 408 to the flux weakening control unit 403 and the addition unit 409.

In order to properly determine whether or not the power supply ripple compensation control operates as expected, threshold setting is important. In particular, in the field of refrigeration cycle applied apparatuses where there is a wide variety of products with different current ratings, a preferable embodiment is to set, for each product or model, a threshold that is specialized for the product or model. Accordingly, in the first embodiment, as illustrated in FIG. 4, a threshold “a” as a first threshold is determined on the basis of a positive peak value that is the maximum value of the capacitor voltage V_{dc} when the power supply ripple compensation control is not performed. Moreover, a threshold “b” as a second threshold is set on the basis of a negative peak value that is the minimum value of the capacitor voltage V_{dc} when the power supply ripple compensation control is not performed. The thresholds “a” and “b” are desirably set individually for each product or model. The set thresholds “a” and “b” can be stored in a memory or a processing circuit described later.

As illustrated on the right side of FIG. 4, when the power supply ripple compensation control is performed, the positive and negative peak values of the capacitor voltage V_{dc} are certainly smaller than when the power supply ripple compensation control is not performed. Also, when the power supply ripple compensation control function is working effectively, the positive peak value of the capacitor voltage V_{dc} is smaller than the threshold “a”, and the negative peak value of the capacitor voltage V_{dc} is larger than the threshold “b”. Therefore, when the positive and negative peak values of the capacitor voltage V_{dc} are subjected to threshold determination based on the thresholds “a” and “b” set as described above, it is possible to properly determine whether or not a compensation operation by the power supply ripple compensation control is normal.

Next, the operation of the control unit 400 according to the first embodiment will be described with reference to a flowchart. FIG. 5 is a flowchart provided for explaining the operation of the control unit 400 according to the first embodiment.

The control unit 400 reads the thresholds “a” and “b” from the memory or the processing circuit (step S21). The control unit 400 acquires the detected value of the capacitor voltage V_{dc} from the voltage detection unit 503 (step S22). The control unit 400 calculates the positive and negative peak values of the capacitor voltage V_{dc} on the basis of the detected value acquired (step S23). The control unit 400 compares the positive peak value of the capacitor voltage V_{dc} with the threshold “a” and compares the negative peak value of the capacitor voltage V_{dc} with the threshold “b” (step S24).

If the positive peak value of the capacitor voltage V_{dc} is smaller than the threshold “a” and the negative peak value of the capacitor voltage V_{dc} is larger than the threshold “b” (Yes in step S25), the control unit 400 determines that the power supply ripple compensation control function is normal (step S26). The operation thereafter returns to step S22, and the processing from step S22 is repeated.

If the positive peak value of the capacitor voltage V_{dc} is larger than or equal to the threshold “a” or the negative peak value of the capacitor voltage V_{dc} is smaller than or equal to the threshold “b” (No in step S25), the control unit 400 determines that the power supply ripple compensation control function is not normal (step S27). In this case, the control unit 400 performs control of reducing the drive speed of the motor 314 (step S28). The operation thereafter returns to step S22, and the processing from step S22 is repeated.

An additional description will be given for the above processing. When the control of reducing the drive speed of the motor 314 is performed in step S28, the power supply ripple compensation control function may be determined to be normal in the processing of steps S25 and S26. In this case, the drive speed of the motor 314 is returned to a command speed, and the processing of FIG. 5 is performed again. Then, if the power supply ripple compensation control function is determined to be not normal, the operation of the power converter 1 is stopped, and the driving of the motor 314 is discontinued. Note that, in the present description, the control of reducing the drive speed of the motor 314 or the control of stopping the driving of the motor 314 may be referred to as “second control”.

Moreover, in step S25, if the positive peak value of the capacitor voltage V_{dc} is equal to the threshold “a” or if the negative peak value of the capacitor voltage V_{dc} is equal to the threshold “b”, the determination is “No”, but the determination may be “Yes”. That is, if the positive peak value of the capacitor voltage V_{dc} is larger than the threshold “a” or if the negative peak value of the capacitor voltage V_{dc} is smaller than the threshold “b”, the power supply ripple compensation control function may be determined to be not normal.

Next, a hardware configuration for implementing the functions of the control unit 400 according to the first embodiment will be described with reference to FIGS. 6 and 7. FIG. 6 is a block diagram illustrating an example of the hardware configuration that implements the functions of the control unit 400 according to the first embodiment. FIG. 7 is a block diagram illustrating another example of the hardware configuration that implements the functions of the control unit 400 according to the first embodiment.

When some or all of the functions of the control unit 400 are implemented, as illustrated in FIG. 6, the hardware configuration can include a processor 420 that performs an arithmetic operation, a memory 422 that saves programs to be read by the processor 420, and an interface 424 that inputs and outputs signals.

The processor 420 is an example of arithmetic means. The processor 420 may be arithmetic means called a microprocessor, a microcomputer, a central processing unit (CPU), or a digital signal processor (DSP). The memory 422 can include, for example, a non-volatile or volatile semiconductor memory such as a random access memory (RAM), a read only memory (ROM), a flash memory, an erasable programmable ROM (EPROM), or an electrically EPROM (EEPROM (registered trademark)), a magnetic disk, a flexible disk, an optical disk, a compact disc, a mini disc, or a digital versatile disc (DVD).

The memory 422 stores programs for executing the functions of the control unit 400 and set values of the thresholds “a” and “b” described above. The processor 420 transmits and receives necessary information via the interface 424, executes the programs stored in the memory 422, and refers to data including the thresholds “a” and “b” stored in the memory 422, thereby being able to execute the processing described above. A result of arithmetic operation by the processor 420 can be stored in the memory 422.

Moreover, the processor 420 and the memory 422 illustrated in FIG. 6 may be replaced with a processing circuit 423 as in FIG. 7. The processing circuit 423 corresponds to a single circuit, a complex circuit, an application specific integrated circuit (ASIC), a field-programmable gate array (FPGA), or a combination of these. Information to be input to the processing circuit 423 and information to be output from the processing circuit 423 can be obtained via the interface 424.

Note that some processing of the control unit 400 may be implemented by the processing circuit 423, and processing not implemented by the processing circuit 423 may be implemented by the processor 420 and the memory 422.

As described above, in the power converter according to the first embodiment, the control unit performs the first control of reducing the ripple of the capacitor current that is the charge/discharge current of the capacitor by controlling the inverter. Moreover, the control unit determines whether or not the compensation operation by the first control is normal and, if determining that the compensation operation is not normal, performs the second control of reducing the drive speed of the motor or stopping the driving of the motor. As a result, when the first control as the power supply ripple compensation control does not operate as expected, an appropriate response can be made. In addition, the determination processing according to the first embodiment can determine whether or not the power supply ripple compensation control function is working effectively, which makes it easy to identify the site of a failure in the power converter. Moreover, in the case of a failure of only the power supply ripple compensation control function, the operation can be performed with limited functions so that the determination serves as useful information for a user and a maintenance worker.

Note that the first and second thresholds for determining whether or not the compensation operation by the first control, which is the power supply ripple compensation control, is normal can be set on the basis of the maximum value and the minimum value of the capacitor voltage when the first control is not performed. The use of the first and second thresholds set in this manner enables proper determination of whether or not the power supply ripple compensation control function is working effectively. In addition, such a setting method is useful in the field of refrigeration cycle applied apparatuses where there is a wide variety of products with different current ratings.

### Second Embodiment

A second embodiment will describe a threshold setting method different from that in the first embodiment. Note that the operation of the second embodiment can be implemented by components that are identical or equivalent to those of the power converter 1 illustrated in FIG. 1 and the control unit 400 illustrated in FIG. 2.

FIG. 8 is a set of graphs provided for explaining the threshold setting method in the second embodiment. The left side of FIG. 8 illustrates a time-varying waveform of the capacitor voltage V_{dc} in a case where power supply ripple compensation control is not performed. The right side of FIG. 8 illustrates a time-varying waveform of the capacitor voltage V_{dc} in a case where the power supply ripple compensation control is performed.

In the second embodiment, as illustrated in FIG. 8, a threshold “c” as a third threshold is determined on the basis of a ripple width of the capacitor voltage V_{dc} when the power supply ripple compensation control is not performed. The ripple width here is an absolute value of a difference between an instantaneous value of the capacitor voltage V_{dc} and an average value of the capacitor voltage V_{dc}. The threshold “c” is desirably set individually for each product or model. The set threshold “c” can be stored in the memory 422 or the processing circuit 423.

As illustrated on the right side of FIG. 8, the ripple width of the capacitor voltage V_{dc} when the power supply ripple compensation control is performed is certainly smaller than the ripple width of the capacitor voltage V_{dc} when the power supply ripple compensation control is not performed. Therefore, when the instantaneous value of the capacitor voltage V_{dc} at the time the power supply ripple compensation control is performed is subjected to threshold determination based on the threshold “c” set on the basis of the ripple width of the capacitor voltage V_{dc} at the time the power supply ripple compensation control is not performed, it is possible to properly determine whether or not the compensation operation by the power supply ripple compensation control is normal.

FIG. 9 is a flowchart provided for explaining an operation of the control unit 400 according to the second embodiment. The control unit 400 reads the threshold “c” from the memory 422 or the processing circuit 423 (step S31). The control unit 400 acquires the detected value of the capacitor voltage V_{dc} from the voltage detection unit 503 (step S32). The control unit 400 calculates a peak value and the average value of the capacitor voltage V_{dc} on the basis of the detected value acquired (step S33). The control unit 400 calculates the ripple width from the peak value and the average value of the capacitor voltage V_{dc} (step S34). The control unit 400 compares the ripple width calculated in step S34 with the threshold “c” (step S35).

If the ripple width calculated in step S34 is smaller than the threshold “c” (Yes in step S36), the control unit 400 determines that the power supply ripple compensation control function is normal (step S37). The operation thereafter returns to step S32, and the processing from step S32 is repeated.

If the ripple width calculated in step S34 is larger than or equal to the threshold “c” (No in step S36), the control unit 400 determines that the power supply ripple compensation control function is not normal (step S38). In this case, the control unit 400 performs control of reducing the drive speed of the motor 314 (step S39). The operation thereafter returns to step S32, and the processing from step S32 is repeated.

An additional description will be given for the above processing. When the control of reducing the drive speed of the motor 314 is performed in step S39, the power supply ripple compensation control function may be determined to be normal in the processing of steps S36 and S37. In this case, the drive speed of the motor 314 is returned to a command speed, and the processing of FIG. 9 is performed again. Then, if the power supply ripple compensation control function is determined to be not normal, the operation of the power converter 1 is stopped, and the driving of the motor 314 is discontinued.

Moreover, in step S36, if the ripple width is equal to the threshold “c”, the determination is “No”, but the determination may be “Yes”. That is, if the ripple width is larger than the threshold “c”, the power supply ripple compensation control function may be determined to be not normal.

Note that, in the above processing, the ripple width is calculated as the absolute value of the difference between the instantaneous value of the capacitor voltage V_{dc} and the average value of the capacitor voltage V_{dc}, but the present disclosure is not limited to this example. As expressed by the following Formula (1), the ripple width may be obtained by a root mean square calculation in which the square of the difference between the instantaneous value of the capacitor voltage and the average value of the capacitor voltage is averaged over an arbitrary time T.

$$\begin{matrix}Formula 1 & \\ \sqrt{\frac{1}{T} \int {\{ instantaneous value - average value \}}^{2} dt} & ( 1 )\end{matrix}$$

When the definition of the ripple width is “the absolute value of the difference between the instantaneous value of the capacitor voltage V_{dc} and the average value of the capacitor voltage V_{dc}”, there is a concern that the ripple width increases if the instantaneous value increases even once due to noise, for example. On the other hand, as in the above Formula (1), in the case of the root mean square calculation that performs integration and averaging over an arbitrary time, the calculated value increases when the instantaneous value continues to be large, whereby the influence of accidental noise can be reduced or prevented. Therefore, when the ripple width is calculated using the above Formula (1), a more accurate threshold can be obtained so that the accuracy of determining whether or not the power supply ripple compensation control function is normal can be improved.

As described above, according to the determination processing of the second embodiment, the third threshold for determining whether or not the compensation operation by the first control, which is the power supply ripple compensation control, is normal can be determined on the basis of the absolute value of the difference between the instantaneous value of the capacitor voltage when the first control is not performed and the average value of the capacitor voltage when the first control is not performed. The use of the third threshold set in this manner enables proper determination of whether or not the power supply ripple compensation control function is working effectively. In addition, such a setting method is useful in the field of refrigeration cycle applied apparatuses where there is a wide variety of products with different current ratings.

Note that the third threshold may be set on the basis of a root mean square value obtained by averaging the square of the difference between the instantaneous value of the capacitor voltage and the average value of the capacitor voltage over an arbitrary time. The use of the third threshold set on the basis of such a root mean square calculation can improve the accuracy of determining whether or not the power supply ripple compensation control function is normal.

### Third Embodiment

A third embodiment will describe a determination method using a threshold different from that in the first and second embodiments. Note that the operation of the third embodiment can be implemented by components that are identical or equivalent to those of the power converter 1 illustrated in FIG. 1 and the control unit 400 illustrated in FIG. 2.

FIG. 10 is a flowchart provided for explaining an operation of the control unit 400 according to the third embodiment. The control unit 400 reads a threshold “d” as a fourth threshold from the memory 422 or the processing circuit 423 (step S41). The threshold “d” is a threshold set on the basis of the capacitor current I3 when the power supply ripple compensation control is not performed.

The control unit 400 acquires the detected value of the capacitor voltage V_{dc} from the voltage detection unit 503 (step S42). The control unit 400 calculates the capacitor current I3 on the basis of the detected value acquired and a capacitance C of the capacitor 210 (step S43). Specifically, the capacitor current I3 can be calculated by the following Formula (2) on the basis of the capacitor voltage V_{dc} and the capacitance C of the capacitor 210.

$$I 3 = C \cdot ( {dV}_{dc} / dt ) \qquad ( 2 )$$

The control unit 400 compares the capacitor current I3 calculated in step S43 with the threshold “d” (step S44). If the capacitor current I3 calculated in step S43 is smaller than the threshold “d” (Yes in step S45), the control unit 400 determines that the power supply ripple compensation control function is normal (step S46). The operation thereafter returns to step S42, and the processing from step S42 is repeated.

If the capacitor current I3 calculated in step S43 is larger than or equal to the threshold “d” (No in step S45), the control unit 400 determines that the power supply ripple compensation control function is not normal (step S47). In this case, the control unit 400 performs control of reducing the drive speed of the motor 314 (step S48). The operation thereafter returns to step S42, and the processing from step S42 is repeated.

An additional description will be given for the above processing. When the control of reducing the drive speed of the motor 314 is performed in step S48, the power supply ripple compensation control function may be determined to be normal in the processing of steps S45 and S46. In this case, the drive speed of the motor 314 is returned to a command speed, and the processing of FIG. 10 is performed again. Then, if the power supply ripple compensation control function is determined to be not normal, the operation of the power converter 1 is stopped, and the driving of the motor 314 is discontinued.

Moreover, in step S45, if the capacitor current I3 is equal to the threshold “d”, the determination is “No”, but the determination may be “Yes”. That is, if the capacitor current I3 is larger than the threshold “d”, the power supply ripple compensation control function may be determined to be not normal.

As described above, according to the determination processing of the third embodiment, the fourth threshold for determining whether or not the compensation operation by the first control, which is the power supply ripple compensation control, is normal can be set on the basis of the instantaneous value of the capacitor voltage when the first control is not performed and the capacitor current when the first control is not performed. In addition, the capacitor current can be obtained by calculation on the basis of the detected value of the capacitor voltage and the capacitance of the capacitor. The use of the fourth threshold set in this manner enables proper determination of whether or not the power supply ripple compensation control function is working effectively. In addition, such a setting method is useful in the field of refrigeration cycle applied apparatuses where there is a wide variety of products with different current ratings.

### Fourth Embodiment

A fourth embodiment will describe a determination method different from that in the first to third embodiments. FIG. 11 is a diagram illustrating an example of a configuration of a power converter 1A according to the fourth embodiment. In the power converter 1A illustrated in FIG. 11, a current detection unit 504 that detects the capacitor current I3 is added. The power converter 1A and the motor 314 included in the compressor 315 make up a motor drive apparatus 2A. The rest of the configuration is identical or equivalent to that of the power converter 1 illustrated in FIG. 1, so that components identical or equivalent to those of the power converter 1 illustrated in FIG. 1 are denoted by the same reference numerals as those in FIG. 1, and a redundant description will be omitted. Note that, in the present description, the current detection unit 504 may be simply referred to as a “detection unit”.

FIG. 12 is a flowchart provided for explaining an operation of the control unit 400 according to the fourth embodiment. The control unit 400 reads the threshold “d” as the fourth threshold from the memory 422 or the processing circuit 423 (step S51). Similarly to the third embodiment, the threshold “d” is the threshold set on the basis of the capacitor current I3 when the power supply ripple compensation control is not performed.

The control unit 400 acquires the detected value of the capacitor current I3 from the current detection unit 504 (step S52). The control unit 400 compares the detected value of the capacitor current I3 acquired in step S52 with the threshold “d” (step S53). If the capacitor current I3 is smaller than the threshold “d” (Yes in step S54), the control unit 400 determines that the power supply ripple compensation control function is normal (step S55). The operation thereafter returns to step S52, and the processing from step S52 is repeated.

If the detected value of the capacitor current I3 acquired in step S52 is larger than or equal to the threshold “d” (No in step S54), the control unit 400 determines that the power supply ripple compensation control function is not normal (step S56). In this case, the control unit 400 performs control of reducing the drive speed of the motor 314 (step S57). The operation thereafter returns to step S52, and the processing from step S52 is repeated.

An additional description will be given for the above processing. When the control of reducing the drive speed of the motor 314 is performed in step S57, the power supply ripple compensation control function may be determined to be normal in the processing of steps S54 and S55. In this case, the drive speed of the motor 314 is returned to a command speed, and the processing of FIG. 12 is performed again. Then, if the power supply ripple compensation control function is determined to be not normal, the operation of the power converter 1A is stopped, and the driving of the motor 314 is discontinued.

Moreover, in step S54, if the detected value of the capacitor current I3 is equal to the threshold “d”, the determination is “No”, but the determination may be “Yes”. That is, if the detected value of the capacitor current I3 is larger than the threshold “d”, the power supply ripple compensation control function may be determined to be not normal.

As described above, according to the determination processing of the fourth embodiment, the fourth threshold for determining whether or not the compensation operation by the first control, which is the power supply ripple compensation control, is normal can be set on the basis of the detected value of the capacitor current when the first control is not performed. The use of the fourth threshold set in this manner enables proper determination of whether or not the power supply ripple compensation control function is working effectively. In addition, such a setting method is useful in the field of refrigeration cycle applied apparatuses where there is a wide variety of products with different current ratings.

### Fifth Embodiment

FIG. 13 is a diagram illustrating an example of a configuration of a refrigeration cycle applied apparatus 900 according to a fifth embodiment. The refrigeration cycle applied apparatus 900 according to the fifth embodiment includes the power converter 1 described in the first to third embodiments. The refrigeration cycle applied apparatus 900 according to the fifth embodiment can be applied to a product including a refrigeration cycle, such as an air conditioner, a refrigerator, a freezer, or a heat pump water heater. Note that in FIG. 13, a component having a function similar to that of the first to third embodiments is assigned the same reference numeral as that assigned to the corresponding component in the first to third embodiments.

In the refrigeration cycle applied apparatus 900, the compressor 315 incorporating the motor 314 of the first embodiment, a four-way valve 902, an indoor heat exchanger 906, an expansion valve 908, and an outdoor heat exchanger 910 are installed via refrigerant piping 912.

Inside the compressor 315, a compression mechanism 904 that compresses a refrigerant and the motor 314 that causes the compression mechanism 904 to operate are provided.

The refrigeration cycle applied apparatus 900 can perform heating operation or cooling operation by switching of the four-way valve 902. The compression mechanism 904 is driven by the motor 314 subjected to variable speed control.

At the time of the heating operation, as indicated by solid arrows, the refrigerant is pressurized and delivered by the compression mechanism 904, passes through the four-way valve 902, the indoor heat exchanger 906, the expansion valve 908, the outdoor heat exchanger 910, and the four-way valve 902, and returns to the compression mechanism 904.

At the time of the cooling operation, as indicated by broken arrows, the refrigerant is pressurized and delivered by the compression mechanism 904, passes through the four-way valve 902, the outdoor heat exchanger 910, the expansion valve 908, the indoor heat exchanger 906, and the four-way valve 902, and returns to the compression mechanism 904.

At the time of the heating operation, the indoor heat exchanger 906 acts as a condenser to release heat, and the outdoor heat exchanger 910 acts as an evaporator to absorb heat. At the time of the cooling operation, the outdoor heat exchanger 910 acts as a condenser to release heat, and the indoor heat exchanger 906 acts as an evaporator to absorb heat. The expansion valve 908 decompresses and expands the refrigerant.

Note that in the above description, the refrigeration cycle applied apparatus 900 according to the fifth embodiment includes the power converter 1 described in the first to third embodiments, but the present disclosure is not limited thereto. The refrigeration cycle applied apparatus 900 may include the power converter 1A illustrated in FIG. 11. Alternatively, as long as the control methods of the first to fourth embodiments can be applied, a power converter other than the power converters 1 and 1A may be used.

The configurations illustrated in the above embodiments each illustrate an example, therefore, so that another known technique can be combined, the two or more embodiments can be combined together, or the configurations can be partially omitted and/or modified without departing from the scope of the present disclosure.

1. A power converter comprising:
rectifier circuitry that rectifies a power supply voltage applied from an alternating-current power supply;
a capacitor connected to an output end of the rectifier circuitry;
an inverter that is connected across the capacitor, converts direct-current power output from the capacitor into alternating-current power, and outputs the alternating-current power to a device equipped with a motor; and
control circuitry that performs first control of reducing ripple of a capacitor current, which is a charge/discharge current of the capacitor, by controlling the inverter, wherein
the control circuitry determines whether or not a compensation operation by the first control is normal, and
when determining that the compensation operation is not normal, the control circuitry performs second control of reducing a drive speed of the motor or stopping driving of the motor.

2. The power converter according to claim 1, comprising
voltage detection circuitry that detects a capacitor voltage as a voltage of the capacitor, wherein
the control circuitry calculates positive and negative peak values of the capacitor voltage on the basis of a detected value of the capacitor voltage,
when the positive peak value is larger than a first threshold or when the negative peak value is smaller than a second threshold, the control circuitry determines that the compensation operation by the first control is not normal, and
the first threshold is set on the basis of a maximum value of the capacitor voltage when the first control is not performed, and the second threshold is set on the basis of a minimum value of the capacitor voltage when the first control is not performed.

3. The power converter according to claim 1, comprising
voltage detection circuitry that detects a capacitor voltage as a voltage of the capacitor, wherein
the control circuitry calculates an average value of the capacitor voltage on the basis of a detected value of the capacitor voltage,
when a ripple width that is an absolute value of a difference between an instantaneous value and the average value of the capacitor voltage is larger than a third threshold, the control circuitry determines that the compensation operation by the first control is not normal, and
the third threshold is set on the basis of the absolute value of the difference between the instantaneous value of the capacitor voltage when the first control is not performed and the average value of the capacitor voltage when the first control is not performed.

4. The power converter according to claim 3, wherein
the ripple width is obtained by a root mean square calculation in which a square of the difference between the instantaneous value of the capacitor voltage and the average value of the capacitor voltage is averaged over an arbitrary time.

5. The power converter according to claim 1, comprising
voltage detection circuitry that detects a capacitor voltage as a voltage of the capacitor, wherein
the control circuitry calculates the capacitor current on the basis of a detected value of the capacitor voltage and a capacitance of the capacitor,
when the capacitor current is larger than a fourth threshold, the control circuitry determines that the compensation operation by the first control is not normal, and
the fourth threshold is set on the basis of a calculated value of the capacitor current when the first control is not performed.

6. The power converter according to claim 1, comprising
current detection circuitry that detects the capacitor current, wherein
when a detected value of the capacitor current is larger than a fourth threshold, the compensation operation by the first control is determined to be not normal, and
the fourth threshold is set on the basis of the detected value of the capacitor current when the first control is not performed.

7. A motor drive apparatus comprising the power converter according to claim 1.

8. A refrigeration cycle applied apparatus comprising the power converter according to claim 1.

9. A motor drive apparatus comprising the power converter according to claim 2.

10. A motor drive apparatus comprising the power converter according to claim 3.

11. A motor drive apparatus comprising the power converter according to claim 4.

12. A motor drive apparatus comprising the power converter according to claim 5.

13. A motor drive apparatus comprising the power converter according to claim 6.

14. A refrigeration cycle applied apparatus comprising the power converter according to claim 2.

15. A refrigeration cycle applied apparatus comprising the power converter according to claim 3.

16. A refrigeration cycle applied apparatus comprising the power converter according to claim 4.

17. A refrigeration cycle applied apparatus comprising the power converter according to claim 5.

18. A refrigeration cycle applied apparatus comprising the power converter according to claim 6.
